(19) United States
(12) Patent Application Publication
(10) Pub. No.: US 2011/0260638 A1
(43) Pub. Date: Oct. 27, 2011

(54) REFLECTOR-TYPE LAMP WITH INTEGRATED HEAT DISTRIBUTION AND EMI SHIELDING

(75) Inventors: James Gotay, Lowell, MA (US); George Mortimer, Park Forest, IL (US); Heinz W. Ito, Topsfield, MA (US); Kenneth Grossman, Beverly, MA (US)

(73) Assignee: OSRAM SYLVANIA INC., Danvers, MA (US)

(21) Appl. No.: 12/767,532

(22) Filed: Apr. 26, 2010

(51) Int. Cl. H05B 41/36; H01J 61/52

(52) U.S. Cl. 315/291; 313/46

(57) ABSTRACT

Reflector-type lamps and housings with integrated heat distribution and EMI shielding are disclosed. A reflector-type lamp includes a lamp housing having a base portion, a reflector portion, and an integrated heat distribution structure. A light source may be located in a reflector housing region or cavity defined by the reflector portion and integrated electronics may be located in a base housing region or cavity defined by the base portion. In general, the heat distribution structure distributes heat from hot spots in the lamp to exterior locations along the base portion and/or reflector portion. The heat distribution structure may also provide electromagnetic interference (EMI) shielding when EMI is generated within the lamp, for example, in the integrated electronics.

### TECHNICAL FIELD

The present application relates to lamps, and more particularly to a reflector-type lamp including a lamp housing with integrated heat distribution and EMI shielding.

### BACKGROUND

Lighting technology has significantly advanced with the development of lamps using new, more energy efficient light sources, such as gas discharge light sources and light emitting diode (LED) light sources. Due to the energy efficiency and longer life, such lamps have become desirable as a replacement for conventional incandescent lamps. Gas discharge lamps and LED-based lamps, however, operate differently than incandescent lamps. To be used in existing lighting fixtures designed for incandescent lamps, gas discharge lamps and LED-based lamps often include integrated electronics, such as ballasts and LED driver circuits, to regulate the current supplied to the light sources.

### SUMMARY

Despite the improved energy efficiency of these lamps, the advances in lighting technology have also brought about new challenges in lamp design. In particular, the light sources in these lamps often have increased operating temperatures. Excessive heat buildup may cause melting or other damage to the plastic housings that hold the light sources and electronics, thereby preventing operation of the lamp and/or causing injury or other hazards. In some reflector-type lamps, the excessive heat inside of the reflector cavity may also cause evaporation of the plastic material and/or the basing cement. The evaporated materials may be re-deposited on the inside of the reflector or lens, which may result in lumen depreciation of the lamp. Excessive heat buildup on the plastic may also result in darkening and discoloration of the plastic on the outside of the lamp housing.

The integrated electronics in these lamps may also cause electromagnetic interference (EMI). LED-based lamps, in particular, may generate significant EMI as a result of the switching performed by the LED driver circuit. EMI may adversely affect the operation of other electronic devices.

Although some attempts have been made to distribute heat and provide EMI shielding in lamps, these previous attempts have been limited to certain types of lamp designs and have used heat sinks and EMI shields inside of the lamp housing. In some lamp designs, however, incorporating heat distribution and EMI presents unique challenges because of the structure of the lamp housing. The limited space inside of certain types of lamp housings may not accommodate heat sinks and EMI shields. Moreover, heat sinks and EMI shields on the inside of the housing may only provide limited heat distribution and shielding. Incorporating heat distribution and/or EMI shielding in reflector-type lamps is also challenging because the lamp housings have a more complicated design that incorporates a reflector to reflect the light to one end of the lamp. As mentioned above, the reflector-type lamp is more susceptible to performance degradation, for example, when evaporated material is re-deposited on the reflector. Providing a desired lamp height profile may also be a challenge, for example, in reflector-type lamps that include integrated electronics and that are used for downlighting. Other challenges with designing lamp housings to provide heat distribution and EMI shielding include the avoidance of electric shock.

Embodiments of the present invention provide a reflector-type lamp including a lamp housing having a base portion, a reflector portion and an integrated heat distribution structure. A light source may be located in a reflector housing region or cavity defined by the reflector portion and integrated electronics may be located in a base housing region or cavity defined by the base portion. In general, the heat distribution structure distributes heat from hot spots in the lamp to exterior locations along the base portion and/or reflector portion. The heat distribution structure may also provide electromagnetic interference (EMI) shielding when EMI is generated within the lamp, for example, in the integrated electronics. Thus, an integrated heat distribution structure, according to embodiments described herein, may be used to distribute heat from hot spots on a reflector-type lamp to external locations on a base portion and/or reflector portion of the lamp housing, thereby preventing damage to the lamp housing. In at least some embodiments, the integrated heat distribution structure further provides structural reinforcement by holding together the base portion and reflector portion of the housing. The integrated heat distribution structure may also provide EMI shielding to prevent or minimize problems with other electronic devices or other hazards that may be caused by radiated EMI from the lamp. Further, the integrated heat distribution structure may, in some embodiments, be used in place of a reflector that reflects light emitted in the direction of the ballast of a lamp; such light, though perhaps minimal, would otherwise be lost.

In an embodiment, there is provided a reflector-type lamp. The reflector-type lamp includes: a lamp housing including a base portion defining a base housing region and a reflector portion extending from proximate one end of the base portion and defining a reflector housing region; an integrated heat distribution structure extending around an outside of at least part of the reflector portion and extending around an outside of at least part of the base portion, the heat distribution structure being made of a thermally conductive material that is more thermally conductive than materials of the reflector portion and the base portion and that is capable of providing EMI shielding; a light source located in the reflector housing region of the lamp housing; and a driver circuit located in the base housing region of the lamp housing and coupled to the light source through the base portion, the driver circuit being configured to regulate current provided to the light source and configured to generate EMI.

In a related embodiment, the integrated heat distribution structure may further extend between the base portion and the reflector portion. In another related embodiment, the heat distribution structure may further extend between the base portion and the reflector portion such that the heat distribution structure holds the base portion and the reflector portion together. In yet another related embodiment, the thermally conductive material may include metal, and the materials of the reflector portion and the base portion may include plastic.

In still another related embodiment, the reflector portion may include a tapered structure, and the base portion may include a cap structure. In yet still another related embodiment, the heat distribution structure may include a unitary structure extending around the reflector portion and the base portion. In still yet another related embodiment, the heat distribution structure may include a multiple piece structure thermally coupled together. In yet still another related embodiment, the light source may include electrodes coupling the light source to the driver circuit, and the heat distribution structure may extend to at least one hot spot region proximate the electrodes such that the heat distribution structure distributes heat away from the hot spot region.

In another related embodiment, the light source may include a solid state lighting light source. In a further related embodiment, the solid state lighting light source may be a light emitting diode (LED) light source. In another related embodiment, the light source may include a gas discharge light source.

In another embodiment, there is provided a lamp. The lamp includes: a lamp housing including a base portion defining a base housing region and a reflector portion extending from proximate one end of the base portion and defining a reflector housing region; a heat distribution structure extending around and in contact with an outside of at least part of the base portion and the reflector portion of the lamp housing and extending between the base portion and the reflector portion such that the heat distribution structure holds the base portion and the reflector portion together, the base portion and the reflector portion being made of plastic and the heat distribution structure being made of metal, wherein the heat distribution structure is configured to provide EMI shielding; a lens located at one end of the lamp housing; a solid state lighting light source located in the reflector portion of the lamp housing; and a driver circuit located in the base portion of the lamp housing and coupled to the solid state lighting light source, the driver circuit being configured to regulate current provided to the light source and to generate EMI.

In a related embodiment, the solid state lighting light source may be a light emitting diode (LED) light source. In another related embodiment, the heat distribution structure may include a unitary structure extending around the reflector portion and the base portion. In still another related embodiment, the heat distribution portion may extend around a substantial portion of the base portion and the reflector portion.

In yet another embodiment, there is provided a reflector-type lamp housing. The reflector-type lamp housing includes: a base portion defining a base housing region; a reflector portion extending from proximate one end of the base portion and defining a reflector housing region; and an integrated heat distribution structure extending around and in contact with an outside of a substantial portion of the reflector portion, extending around and in contact with an outside of a substantial portion of the base portion, and extending between the base portion and the reflector portion such that the heat distribution structure holds the base portion and the reflector portion together, the heat distribution structure being made of metal and the base portion and the reflector portion being made of plastic, the base portion and the heat distribution portion including at least one aperture configured to receive electrodes for connecting a light source to a driver circuit.

In still another embodiment, there is provided a reflector-type lamp. The reflector-type lamp includes: a lamp housing including a base portion defining a base housing region and a reflector portion extending from proximate one end of the base portion and defining a reflector housing region; a heat distribution structure in contact with an outside of at least part of the base portion and extending from the base portion to form the reflector portion, the heat distribution structure being made of a thermally conductive material that is more thermally conductive than a material of the base portion and that is capable of providing EMI shielding; a light source located in the reflector housing region of the lamp housing; and a driver circuit located in the base housing region of the lamp housing and coupled to the light source, the driver circuit being configured to regulate current provided to the light source and configured to generate EMI.

In yet another embodiment, there is provided a reflector-type lamp. The reflector-type lamp includes: a lamp housing including a base portion defining a base housing region and a reflector portion extending from proximate one end of the base portion and defining a reflector housing region; a heat distribution structure extending between the base portion and the reflector portion and extending around and in contact with an outside of at least part of the base portion and/or the reflector portion, the heat distribution structure being made of a thermally conductive material that is more thermally conductive than a material the base portion and/or the reflector portion and that is capable of providing EMI shielding; a light source located in the reflector housing region of the lamp housing; and a driver circuit located in the base housing region of the lamp housing and coupled to the light source, the driver circuit being configured to regulate current provided to the light source and configured to generate EMI.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 is a side view of a reflector-type lamp according to embodiments described herein.

FIG. 2 is a partially cross-sectional view of a lamp housing of the reflector-type lamp shown in FIG. 1, where the cross-sectional view is taken along line 2-2 in FIG. 1.

FIG. 3 is a top plan view of the lamp housing shown in FIG. 2.

FIG. 4 is a cross-sectional view of a reflector-type lamp housing with a multiple piece heat distribution structure according to embodiments described herein.

FIG. 5 is a cross-sectional view of a reflector-type lamp housing with a multiple piece heat distribution structure according to embodiments described herein.

FIG. 6 is a cross-sectional view of a reflector-type lamp housing with a heat distribution structure extending along only part of the housing according to embodiments described herein.

FIG. 7 is a cross-sectional view of a reflector-type lamp housing with a heat distribution structure extending along only part of the housing according to embodiments described herein.

FIG. 8 is a cross-sectional view of a reflector-type lamp housing with a heat distribution structure that also provides the reflector surface according to embodiments described herein.

FIG. 9 is a cross-sectional view of a reflector-type lamp housing with a heat distribution structure that also provides the reflector surface according to embodiments described herein.

### DETAILED DESCRIPTION

Reflector-type lamps generally include a reflective surface within the lamp housing to reflect light toward a front of the lamp. The reflective surface may be provided by a reflective coating or reflective element, for example but not limited to a coating or element made of a reflective material such as aluminum. Examples of reflector-type lamps include parabolic aluminized reflector (PAR) lamps and ellipsoidal reflector (ER) lamps. Reflector-type lamps may be used, for example, to provide downlighting, floodlighting, or spotlighting.

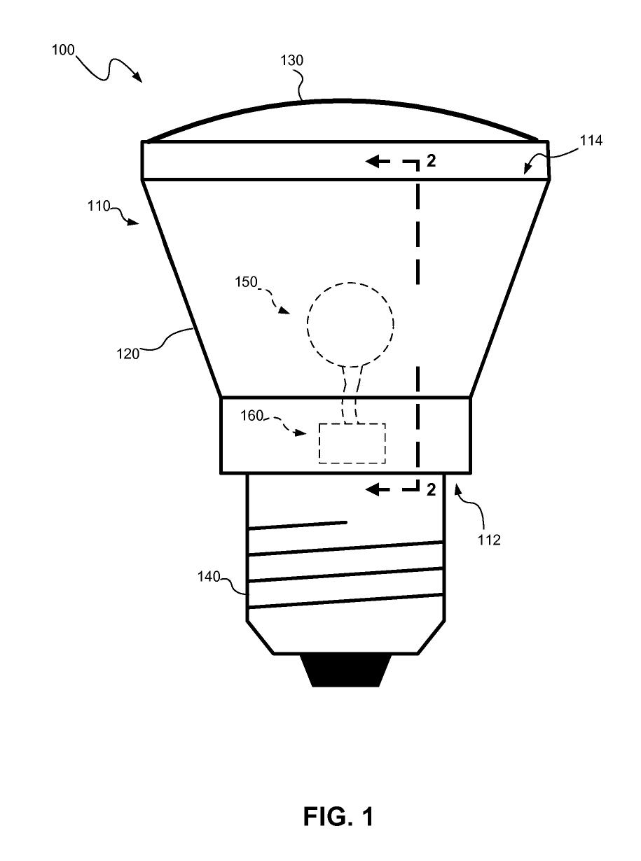

Referring to FIGS. 1-3, one embodiment of a reflector-type lamp 100 is shown. The reflector-type lamp 100 includes a lamp housing 110 with an integrated heat distribution structure 120, a lens 130 at one end of the lamp housing 110, and a connector base 140 at an opposite end of the lamp housing 110. The connector base 140 is shown as a screw-type base, such as the type configured to engage existing lighting fixtures. Alternatively, the reflector-type lamp 100 may include other types of bases including, without limitation, a pin-type base or a bayonet-type base. The reflector-type lamp 100 may also be open without the lens 130 at one end of the housing 110.

The reflector-type lamp 100 further includes a light source 150 located within the lamp housing 110 and coupled to integrated electronics 160 located within the lamp housing 110. In some embodiments, the light source 150 may include one or more solid state lighting sources, such as but not limited to one or more light emitting diodes (LEDs) or organic light emitting diodes (OLEDs), a gas discharge light source such as a fluorescent tube (e.g., in a compact fluorescent (CFL) lamp), and/or a high-intensity discharge (HID) light source. The integrated electronics 160 may include a driver circuit configured to regulate a current supplied to the light source 150. The driver circuit may include, for example, a ballast and/or an LED driver circuit. The integrated electronics 160 may also generate EMI, for example, as a result of the high frequency switching that occurs in an LED driver circuit.

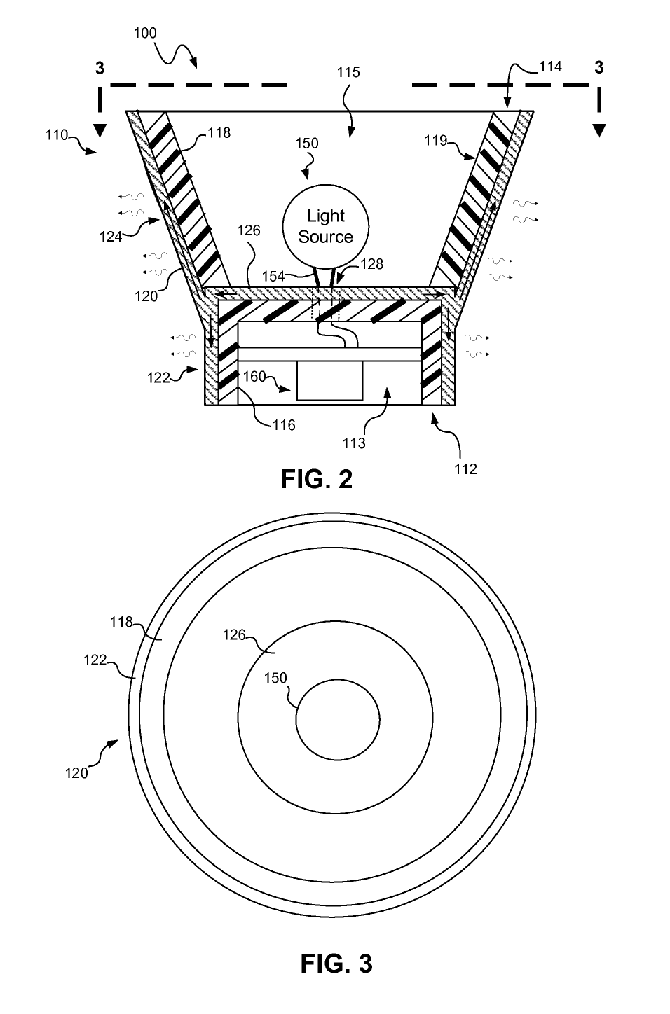

The lamp housing 110, as shown in FIG. 2, includes a base portion 112 defining a base housing region 113 and a reflector portion 114 defining a reflector housing region 115. The light source 150 is located within the reflector housing region 115 and the integrated electronics 160 are located within the base housing region 113. The integrated heat distribution structure 120 extends around an outside of at least part of the base portion 112 and/or extends around an outside of at least part of the reflector portion 114. Although the lamp housing 110 is shown with the heat distribution structure 120 extending around the entire outside surface of the base portion 112 and the reflector portion 114, the heat distribution structure 120 may extend around a substantial portion (e.g., more than 50%) of the external surface of the base portion 112 and/or the reflector portion 114. An integrated heat distribution structure may also extend around only the base portion 112 or only the reflector portion 114, for example, as described in greater detail below. Although the heat distribution portion 120 is shown in contact with the outside surface of the base portion 112 and the reflector portion 114, the heat distribution portion 120 could be spaced from the base portion 112 and/or the reflector portion 114 along at least a section (e.g., to allow air circulation).

As shown in FIG. 2, the base portion 112 of the lamp housing 110 includes a cap structure 116 and the reflector portion 114 of the lamp housing 110 includes a tapered structure 118. The integrated heat distribution structure 120 holds the cap structure 116 and the tapered structure 118 together. The cap structure 116 and the tapered structure 118 may be made of a plastic material such as 30% glass fiber filled, polybutylene terephthalate (30% GFF, PBT). The heat distribution structure 120 may be made from a thermally conductive material that has a higher thermal conductivity than the material of the cap structure 116 and the tapered structure 118 and that is capable of providing EMI shielding. One example of a material having these characteristics is a metal, such as but not limited to aluminum, where the cap structure 116 and tapered structure 118 are made of plastic.

By improving heat distribution and EMI shielding, the light source 150 and/or electronic components (such as the integrated electronics 160) may be arranged in such a way (e.g., closer to the cap structure 116) that the base housing region 113 and/or the reflector housing region 115 may be smaller, thereby lowering the lamp height profile (e.g., by inserting the ballast housing into the middle of a CFLi twist bulb). The improved heat management in the reflector-type lamp 100 may also allow certain lamp designs (e.g., CFLi and high pressure reflector lamps) to be designed with improved operation such as faster lamp start or run-up. In a mercury (Hg) lamp with an integrated heat distribution structure, for example, non-mercury pressure control/low temperature amalgams may be used instead of high temperature/Hg pressure control amalgams, thereby providing a faster lamp run-up. The integrated heat distribution structure may also extend the operating temperature range of certain reflector-type lamps (e.g., low pressure gas discharge light sources such as CFLi), thereby allowing plastics to be used for the reflectors.

The lamp housing 110 may be made by first molding (for example but not limited to injection molding) the cap structure 116 and the tapered structure 118 from plastic and then forming the heat distribution structure 120 from metal around the cap structure 116 and the tapered structure 118. Alternatively, the heat distribution structure 120 may be formed and the cap structure 116 and the tapered structure 118 may be injection molded within the base housing region 113 and the reflector housing region 115 of the heat distribution structure 120, respectively. The heat distribution structure 120 may also be secured to the cap structure 116 and the tapered structure 118 using an adhesive or epoxy. One example of a suitable adhesive is a thermally conductive adhesive such as the type available under the name Loctite 384.

In the embodiment shown in FIG. 2, an inner surface 119 of the tapered structure 118 is reflective and acts as the reflector. In other embodiments, a separate structure may be inserted into the reflector housing region 115 to act as the reflector. The tapered structure 118 may have a generally conical shape or other shape providing tapered sides capable of reflecting light in a desired direction or capable of receiving a separate reflecting element to reflect light in the desired direction. Although the tapered structure 118 is shown with straight or linear sides, it should be understood that the tapered structure 118 may also have sides with a parabolic, ellipsoidal, or other tapered design. Exposed sections of the heat distribution structure 120 may also provide a reflective surface within the reflector housing region 115.

The integrated heat distribution structure 120 as shown in FIGS. 2-3 includes a base heat distribution portion 122 that extends around the cap structure 116, a reflector heat distribution portion 124 that extends around the tapered structure 118, and a connecting or middle heat distribution portion 126 that extends across the lamp housing 110 and between the cap structure 116 and the tapered structure 118. The integrated heat distribution structure 120 may form a shell or shroud around the cap structure 116 and the tapered structure 118 with a thickness that is less than a thickness of the cap structure 116 and/or the tapered structure 118, for example, in a range of about 0.01 mm to about 1.5 mm. The heat distribution structure 120 may be as thick as possible given the design and form factor of the lamp and the thickness may also be determined, at least in part, by the plastic molding process. By covering the cap structure 116 of the base portion 112 and the tapered structure 118 of the reflector portion 114, the heat distribution structure 120 may also prevent discoloration of the plastic in addition to providing structural reinforcement. As shown, the portions 122, 124, 126 of the heat distribution structure 120 may be formed as a unitary one-piece structure. The middle heat distribution portion 126 may further act as a reflector, for example, allowing elimination of the extra reflector disk in many reflector-type lamps.

One or more apertures 128 may be provided through the middle heat distribution section 126 and correspondingly through the cap structure 116 to allow an electrical connection between the light source 150 and the integrated electronics 160 via electrodes 154. An insulating or dielectric material may be provided around the one or more apertures 128 to provide electrical insulation of the electrodes 154 from the heat distribution structure 120. For example, a portion of the plastic material of the cap structure 116 may extend through and around the one or more apertures 128 in the heat distribution structure 120.

The reflector-type lamp 100 may include hot spots proximate the electrodes 154 (i.e., the junction of the light source 150 and the base portion 112) where heat tends to be concentrated in the lamp housing 110. The middle portion 126 of the integrated heat distribution structure 120 extends to these hot spots and conducts heat away from these hot spots to locations external to the lamp 100 on the base portion 112 and/or the reflector portion 114, for example, as shown by the arrows in FIG. 2. The heat may then be dissipated more readily to the surrounding air. In some embodiments, the heat distribution structure 120 may distribute the heat such that the heat at the hot spot is reduced by about 20%. One or more slots or apertures may also be formed through the lamp housing 110 to allow air circulation inside the reflector housing region 115 and/or the base housing region 113 to further reduce heat buildup.

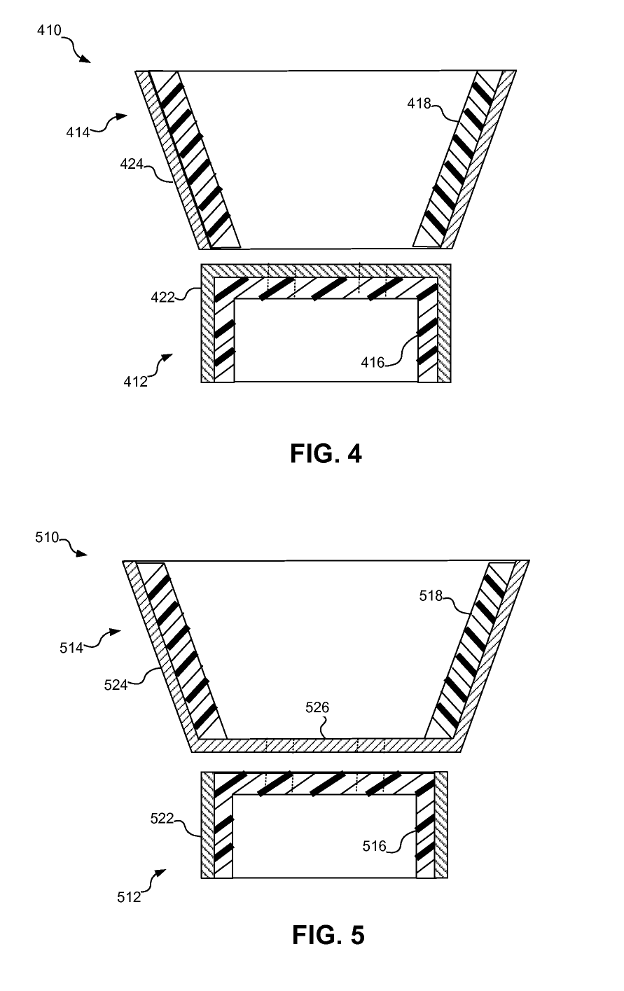

FIGS. 4 and 5 show other embodiments of lamp housings 410, 510 including an integrated heat distribution structure similar to that described above but formed from multiple pieces. As shown in FIG. 4, for example, a base heat distribution structure 422 may be formed around and in contact with an outside of a cap structure 416 to form a base portion 412. A reflector heat distribution structure 424 may be formed around and in contact with an outside of a tapered structure 418 to form a reflector portion 414. The base portion 412 and the reflector portion 414 may then be coupled together such that the heat distribution structures 422, 424 are thermally coupled. For example, a thermally conductive adhesive or epoxy may be used to thermally and mechanically couple the heat distribution structures 422, 424.

The term “coupled” as used herein refers to any connection, coupling, link or the like and does not require a direct physical or electrical connection. As used herein, “thermally coupled” refers to such a connection, coupling, link or the like that allows heat to be transferred from one element to the other thermally coupled element.

As shown in FIG. 5, a base heat distribution structure 522 may be formed around and in contact with an outside of the sides of a cap structure 516 to form a base portion 512. A reflector heat distribution structure 524 may be formed around and in contact with an outside of a tapered structure 518 with a middle portion 526 extending across a narrow end of the tapered structure 518. The structures 522, 524 may be coupled together, for example, using a thermally conductive adhesive or epoxy. Although the base heat distribution structure 522 is shown only around the sides of the cap structure 516, the base heat distribution structure 522 may also extend around the top portion of the cap structure 516 (e.g., similar to the structure 422 shown in FIG. 4). In other embodiments, a heat distribution structure may also be formed on the base portion and the reflector portion of a lamp housing by spraying or coating with a thermally conductive material.

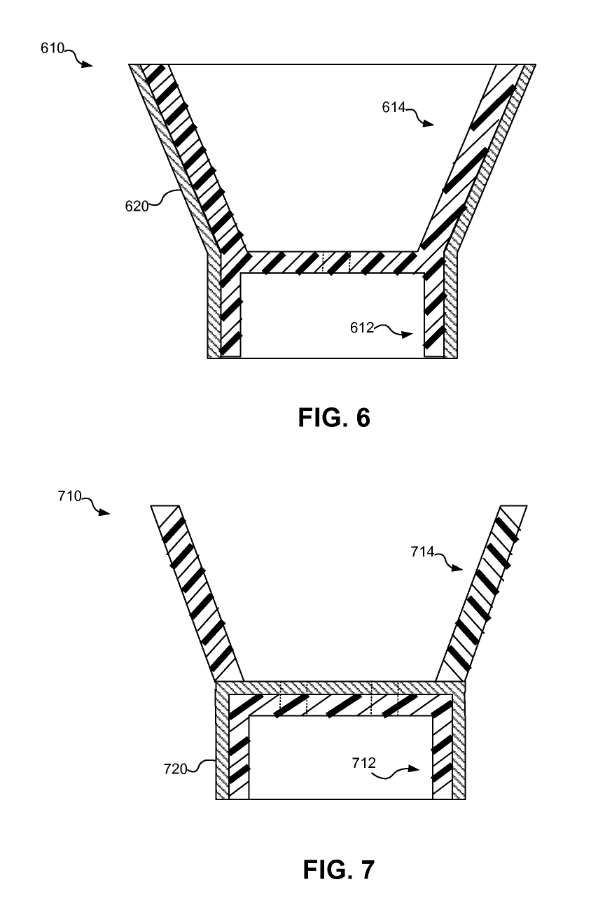

FIGS. 6 and 7 show other embodiments of lamp housings 610, 710 including an integrated heat distribution structure that extends along only part of the housing. As shown in FIG. 6, for example, the integrated heat distribution structure 620 may extend along and in contact with a substantial portion of an outside of a base portion 612 and a reflector portion 614 without extending between the base portion 612 and the reflector portion 614. In this embodiment, the base portion 612 and the reflector portion 614 may be formed as a unitary one-piece structure, for example, molded from plastic. Although not shown in FIG. 6, the heat distribution structure 620 may be thermally coupled to hot spots proximate the location of the electrodes, for example, by having a thermally conductive material, such as metal, extend from the heat distribution structure 620 through the material of the reflector portion 614 to the hot spots. As shown in FIG. 7, a base heat distribution structure 720 may be formed around and in contact with an outside of a base portion 712 with the reflector portion 714 affixed to the heat distribution structure 720, for example, using adhesive or epoxy.

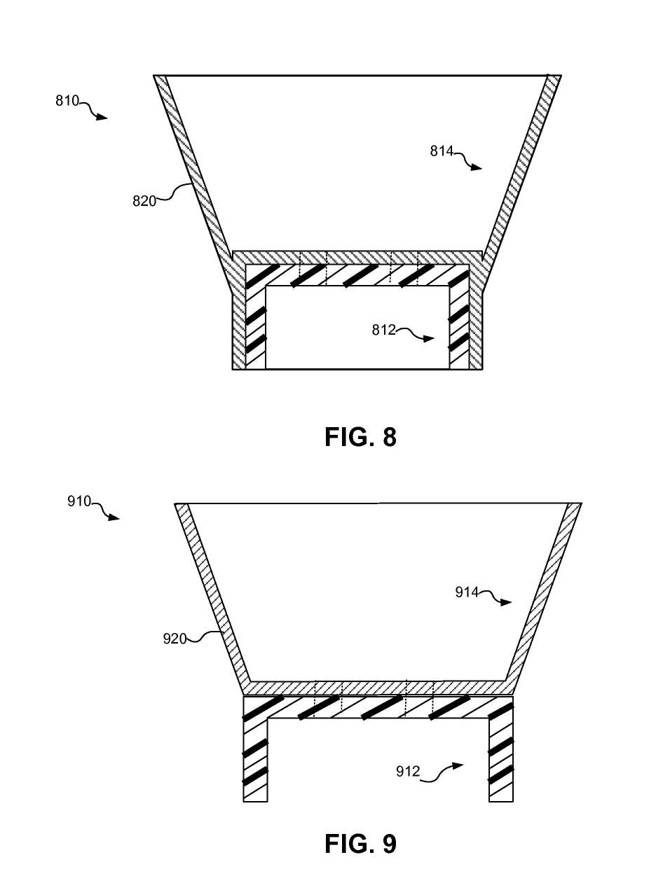

FIGS. 8 and 9 show other embodiments of lamp housings 810, 910 including an integrated heat distribution structure that also provides the reflector surface. As shown in FIG. 8, for example, an integrated heat distribution structure 820, similar to that shown in FIG. 2, could extend around the base portion 812 and extend upwardly to form a reflector portion 814. As shown in FIG. 9, an integrated heat distribution structure 920 may extend upwardly to form a reflector portion 914 without extending around the sides of the base portion 912. In these embodiments, the heat distribution structure 820, 920 may be bonded to the base portion 812, 912, for example, using an adhesive or epoxy such as a thermally conductive adhesive. A lens may also be secured to the heat distribution structure 820, 920, for example, with a glass-to-metal seal. By eliminating plastic inside of the reflector housing region, these embodiments of the lamp housings 810, 910 improve the lumen maintenance of the lamp because evaporated plastic is prevented from being re-deposited on the reflector or the lens.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one, of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A reflector-type lamp comprising:
a lamp housing including a base portion defining a base housing region and a reflector portion extending from proximate one end of the base portion and defining a reflector housing region;
an integrated heat distribution structure extending around an outside of at least part of the reflector portion and extending around an outside of at least part of the base portion, the heat distribution structure being made of a thermally conductive material that is more thermally conductive than materials of the reflector portion and the base portion and that is capable of providing EMI shielding;
a light source located in the reflector housing region of the lamp housing; and
a driver circuit located in the base housing region of the lamp housing and coupled to the light source through the base portion, the driver circuit being configured to regulate current provided to the light source and configured to generate EMI.

2. The reflector-type lamp according to claim 1, wherein the integrated heat distribution structure further extends between the base portion and the reflector portion.

3. The reflector-type lamp according to claim 1, wherein the heat distribution structure further extends between the base portion and the reflector portion such that the heat distribution structure holds the base portion and the reflector portion together.

4. The reflector-type lamp according to claim 1, wherein the thermally conductive material includes metal, and wherein the materials of the reflector portion and the base portion include plastic.

5. The reflector-type lamp according to claim 1, wherein the reflector portion includes a tapered structure, and wherein the base portion includes a cap structure.

6. The reflector-type lamp according to claim 1, wherein the heat distribution structure includes a unitary structure extending around the reflector portion and the base portion.

7. The reflector-type lamp according to claim 1, wherein the heat distribution structure includes a multiple piece structure thermally coupled together.

8. The reflector-type lamp according to claim 1, wherein the light source includes electrodes coupling the light source to the driver circuit, and wherein the heat distribution structure extends to at least one hot spot region proximate the electrodes such that the heat distribution structure distributes heat away from the hot spot region.

9. The reflector-type lamp according to claim 1, wherein the light source includes a solid state lighting light source.

10. The reflector lamp according to claim 9, wherein the solid state lighting light source is a light emitting diode (LED) light source.

11. The reflector-type lamp according to claim 1, wherein the light source includes a gas discharge light source.

12. A lamp comprising:
a lamp housing including a base portion defining a base housing region and a reflector portion extending from proximate one end of the base portion and defining a reflector housing region;
a heat distribution structure extending around and in contact with an outside of at least part of the base portion and the reflector portion of the lamp housing and extending between the base portion and the reflector portion such that the heat distribution structure holds the base portion and the reflector portion together, the base portion and the reflector portion being made of plastic and the heat distribution structure being made of metal, wherein the heat distribution structure is configured to provide EMI shielding;
a lens located at one end of the lamp housing;
a solid state lighting light source located in the reflector portion of the lamp housing; and
a driver circuit located in the base portion of the lamp housing and coupled to the solid state lighting light source, the driver circuit being configured to regulate current provided to the light source and to generate EMI.

13. The lamp according to claim 12, wherein the solid state lighting light source is a light emitting diode (LED) light source.

14. The lamp according to claim 12, wherein the heat distribution structure includes a unitary structure extending around the reflector portion and the base portion.

15. The lamp according to claim 12, wherein the heat distribution portion extends around a substantial portion of the base portion and the reflector portion.

16. A reflector-type lamp housing comprising:
a base portion defining a base housing region;
a reflector portion extending from proximate one end of the base portion and defining a reflector housing region; and
an integrated heat distribution structure extending around and in contact with an outside of a substantial portion of the reflector portion, extending around and in contact with an outside of a substantial portion of the base portion, and extending between the base portion and the reflector portion such that the heat distribution structure holds the base portion and the reflector portion together, the heat distribution structure being made of metal and the base portion and the reflector portion being made of plastic, the base portion and the heat distribution portion including at least one aperture configured to receive electrodes for connecting a light source to a driver circuit.

17. A reflector-type lamp comprising:
a lamp housing including a base portion defining a base housing region and a reflector portion extending from proximate one end of the base portion and defining a reflector housing region;
a heat distribution structure in contact with an outside of at least part of the base portion and extending from the base portion to form the reflector portion, the heat distribution structure being made of a thermally conductive material that is more thermally conductive than a material of the base portion and that is capable of providing EMI shielding;
a light source located in the reflector housing region of the lamp housing; and
a driver circuit located in the base housing region of the lamp housing and coupled to the light source, the driver circuit being configured to regulate current provided to the light source and configured to generate EMI.

18. A reflector-type lamp comprising:
a lamp housing including a base portion defining a base housing region and a reflector portion extending from proximate one end of the base portion and defining a reflector housing region;
a heat distribution structure extending between the base portion and the reflector portion and extending around and in contact with an outside of at least part of the base portion and/or the reflector portion, the heat distribution structure being made of a thermally conductive material that is more thermally conductive than a material the base portion and/or the reflector portion and that is capable of providing EMI shielding;
a light source located in the reflector housing region of the lamp housing; and
a driver circuit located in the base housing region of the lamp housing and coupled to the light source, the driver circuit being configured to regulate current provided to the light source and configured to generate EMI.
